(19) United States
(12) Patent Application Publication
(10) Pub. No.: US 2009/0174627 A1
(43) Pub. Date: Jul. 9, 2009

(54) PLASMA DISPLAY AND DRIVING DEVICE AND METHOD THEREOF

(75) Inventors: Jeong-Hoon Kim, Suwon-si (KR); Hyun Kang, Suwon-si (KR); Youn-Kyoung Kim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/204,101

(22) Filed: Sep. 4, 2008

(30) Foreign Application Priority Data
Jan. 9, 2008 (KR) 10-2008-0002556

(51) Int. Cl. G09G 3/28

(52) U.S. Cl. 345/63

(57) ABSTRACT

A plasma display, a driver for the plasma display, and a driving method thereof apply a reset minimum voltage according to a detected temperature of the plasma display. In the driving method, a reset falling waveform gradually decreasing to a reset minimum voltage is applied to a scan electrode during a falling period of a reset period, and a scan voltage is applied to the scan electrode selected during an address period. An address period is started the voltage applied to the scan electrode reaches the reset minimum voltage. In addition, a voltage difference between the reset minimum voltage and the scan voltage is determined according to a temperature of the plasma display.

### CROSS-REFERENCE TO RELATED APPLICATIONS

This application claims the benefit of Korean Patent Application No. 2008-2556, filed in the Korean Intellectual Property Office on Jan. 9, 2008, the contents of which are incorporated herein by reference.

### BACKGROUND OF THE INVENTION

1. Field of the Invention

Aspects of the present invention relate to a plasma display device and a driver and driving method thereof.

2. Description of the Related Art

A plasma display is a flat panel display that uses plasma generated by a gas discharge to display characters or images. It includes, depending on its size, several to millions of discharge cells (hereinafter, also referred to as “cells”) arranged in a matrix pattern.

One frame of such a plasma display is divided into a plurality of subfields having weight values, and each subfield includes a reset period, an address period, and a sustain period. The reset period is for initializing each discharge cell so as to facilitate an addressing operation on the discharge cell. The address period is for selecting turn-on/turn-off cells (i.e., cells to be turned on or off). And, the sustain period is for causing the cells to either continue discharge to display an image on the addressed cells or to remain inactive.

During the reset period, a reset voltage waveform for gradually decreasing to a reset minimum voltage is applied to the scan electrode. During the address period, a scan voltage that is lower than the reset minimum voltage is applied to the scan electrode to be selected, and an address voltage is selectively applied to the address electrode forming a cell to be selected from cells formed by the scan electrode to which the scan voltage is applied, such that an address discharge is generated.

In addition, heat is generated in a plasma display panel (PDP) by a driver that applies a driving voltage to the PDP when the plasma display is driven. Since the movement of wall charges increases when a temperature of the PDP is increased due to a higher temperature of the PDP, a discharge that is greater than a discharge corresponding to a voltage applied to each electrode may be generated, and the amount of formed wall charges or erased wall charges may be greater than an amount corresponding to an applied voltage.

In addition, as the temperature of the driver increases, characteristics of each element in the driver vary. Particularly, during the reset period, a threshold voltage of a lamp switch that applies a reset falling waveform to the scan electrode varies according to temperature, and generally the threshold voltage is reduced at a high temperature. Accordingly, since a slope of the reset falling waveform becomes steeper when the threshold voltage of the lamp switch is reduced at the high temperature, a strong discharge for eliminating the wall charges may be generated during the reset period. Therefore, contrast deteriorates, a state of wall charges is inverted, and therefore, a low discharge may be generated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of the present invention provide a plasma display that prevents a low discharge regardless of a temperature of a plasma display panel, and a driving device and a driving method thereof.

According to aspects of the present invention, a plasma display includes a plasma display panel including a plurality of first electrodes, a controller, a driver, and a temperature detector. The controller generates a control signal so as to display an externally input video signal on the plasma display panel. The driver applies a driving voltage to the plurality of first electrodes according to the control signal generated by the controller. The temperature detector detects a temperature of the PDP or a temperature of the driver. Here, the controller generates a first control signal for gradually decreasing a voltage applied to the plurality of first electrodes to a first voltage that is higher than a scan voltage during a falling period of a reset period when the temperature transmitted from the temperature detector is less than a reference temperature, and generates a second control signal for gradually decreasing the voltage at the plurality of first electrodes to a second voltage that is higher than the first voltage during the falling period of the reset period when the temperature transmitted from the temperature detector is greater than the reference temperature. In addition, the driver includes a first transistor that is coupled to the plurality of first electrodes and a first power source for supplying the scan voltage during an address period and is turned on during the falling period of the reset period to gradually decrease the voltage at the plurality of first electrodes, and a gate driving circuit that is coupled to a control terminal of the first transistor, the gate driving circuit turns on the first transistor during the part of the reset period, the gate driving circuit turns off the first transistor at a time when the voltage at the plurality of first electrodes is decreased to the first voltage if the first control signal is received from the controller, and the gate driving circuit turns off the first transistor at a time when the voltage at the plurality of first electrodes is decreased to the second voltage if the second control signal is received from the controller.

According to aspects of the present invention, the driver further includes a voltage generator that is coupled between the first transistor and the first power source, the voltage generator generates a third voltage corresponding to a voltage difference between the scan voltage and the first voltage when receiving the first control signal from the controller, and generates a fourth voltage corresponding to a voltage difference between the scan voltage and the second voltage when receiving the second control signal from the controller. The voltage generator includes a third transistor, a first resistor, and a second resistor. The third transistor includes a first terminal coupled to a source of the first transistor and a second terminal coupled to the first power source. The first resistor is coupled between a control terminal of the third transistor and the first terminal of the third transistor. The second resistor is coupled between the control terminal of the third transistor and the second terminal of the third transistor. At least one of the first resistor and the second resistor is a variable resistor having a resistance that varies according to operation of the controller. In addition, the resistance of the first resistor and/or the second resistor varies such that a ratio of the resistance of the first resistor to the resistance of the second resistor may be a first ratio when receiving the first control signal from the controller, and the resistance of the first resistor and/or the second resistor varies such that the ratio of the resistance of the first resistor to the resistance of the second resistor may be a second ratio that is greater than the first ratio.

According to aspects of the present invention, the gate driving circuit coupled to the first transistor includes a comparator and a logic element. The comparator includes a first input terminal coupled to the plurality of first electrodes and a second input terminal coupled to a node of the first transistor and the voltage generator. The comparator outputs a first signal through an output terminal when a voltage applied to the first input terminal is not the same as a voltage applied to the second input terminal, and outputs a second signal that is different from the first signal through the output terminal when the voltage applied to the first input terminal is the same as the voltage applied to the second input terminal. The logic element includes a first input terminal coupled to an output terminal of the comparator and a second input terminal coupled to the controller. The logic element applies a control signal of the first transistor generated by the controller to the second input terminal, and applies an AND operation result of signals respectively applied to the first and second input terminals to the output terminal. In the gate driving circuit coupled to the first transistor, the first voltage is applied to the second input terminal of the comparator when the first control signal is received from the controller, and the second voltage is applied to the second input terminal of the comparator when the second control signal is received from the controller. In addition, the first signal is applied to the first input terminal of the logic element, and a voltage for turning on the first transistor is applied to an output terminal of the logic element when the control signal for turning on the first transistor is applied to the second input terminal of the logic element. A voltage for turning off the first transistor is output to the output terminal of the logic element when the second signal is applied to the first input terminal of the logic element or when the control signal for turning off the first transistor is applied to the second input terminal of the logic element.

According to aspects of the present invention, the driver further includes a second transistor coupled between the first power source and the plurality of first electrodes and that is turned on during the address period, wherein the second transistor is turned on when the second signal is applied to the first input terminal of the logic element in the gate driving circuit coupled to the first transistor.

According to aspects of the present invention, a driving device drives a plasma display including a plurality of scan electrodes. The driving device includes a temperature detector, a first transistor, a voltage generator, a second transistor, and a gate driving circuit. The temperature detector detects a temperature of the plasma display. The first transistor is coupled between a first power source for supplying a scan voltage that is selectively applied to the scan electrode selected from the plurality of scan electrodes during an address period and the plurality of scan electrodes. The voltage generator is coupled between the first power source and the plurality of scan electrodes, generates a first voltage when the temperature detected by the temperature detector is less than a reference temperature, and generates a second voltage that is higher than the first voltage when the temperature detected by the temperature detector is greater than the reference temperature.

According to aspects of the present invention, the second transistor is coupled between the voltage generator and the plurality of scan electrodes, the second transistor is driven to apply a voltage waveform gradually decreasing to a third voltage corresponding to a sum of the scan voltage and the first voltage to the plurality of scan electrodes when the temperature detected by the temperature detector is less than the reference temperature, and the second transistor is driven to apply the gradually decreasing voltage waveform to a fourth voltage corresponding to a sum of the scan voltage and the second voltage to the plurality of scan electrodes when the temperature detected by the temperature detector is greater than the reference temperature. The gate driving circuit of the second transistor applies a turn-off control signal to a gate of the second transistor at a time when a voltage at the plurality of scan electrodes reaches the third voltage if the temperature detected by the temperature detector is less than the reference temperature, and applies the turn-off control signal to the gate of the second transistor at a time when the voltage at the plurality of scan electrodes reaches the fourth voltage if the temperature detected by the temperature detector is greater than the reference temperature.

The voltage generator includes a third transistor, a first resistor, and a second resistor. The third transistor includes a first terminal coupled to a source of the second transistor and a second terminal coupled to the first power source. The first resistor is coupled to a control terminal of the third transistor and the first terminal of the third transistor. The second resistor is coupled between the control terminal of the third transistor and the second terminal of the third transistor. At least one of the first resistor and the second resistor is a variable resistor having resistance that varies according to a resistance control signal output from the controller.

According to aspects of the present invention, the resistance of the first and second resistors is determined such that a ratio of the resistance of the first resistor to the resistance of the second resistor may be a first ratio when the temperature transmitted from the temperature detector is less than the reference temperature, and the resistance of the first and second resistors is determined such that a ratio of the resistance of the first resistor to the resistance of the second resistor may be a second ratio that is greater than the first ratio when the temperature transmitted from the temperature detector is greater than the reference temperature. According to aspects of the present invention, the third transistor is a bipolar transistor.

According to aspects of the present invention, the gate driving circuit coupled to the second transistor includes a comparator and a logic element. The comparator includes a first input terminal coupled to a first terminal of the second transistor coupled to the plurality of scan electrodes and a second input terminal coupled to a node of the voltage generator and the second transistor, and outputs a high level output signal when a voltage applied to the first input terminal is higher than that applied to the second input terminal. The logic element includes a first input terminal coupled to an output terminal of the comparator and a second input terminal coupled to the controller for outputting a turn-on-turn-off control signal of the second transistor, and outputs the high level output signal only when a high level signal is respectively applied to the first input terminal and the second input terminal. Here, a low level output signal is output to the output terminal of the comparator when the voltage applied to the first input terminal of the comparator is lower than that applied to the second input terminal, and the low level output signal is output to an output terminal of the logic element. In addition, the first transistor is turned on when the low level output signal is output to the output terminal of the logic element.

According to aspects of the present invention, a method of driving a plasma display includes detecting a temperature of the plasma display, applying a voltage waveform that is gradually decreasing to a reset minimum voltage to the plurality of scan electrodes during a part of a reset period, selectively applying a first voltage that is lower than the reset minimum voltage to the scan electrode to be selected from the plurality of scan electrodes at a time when a voltage at the plurality of scan electrodes reaches the reset minimum voltage, establishing a voltage difference between the reset minimum voltage and the first voltage to be a second voltage when the temperature of the plasma display is less than a reference temperature, and establishing the voltage difference to be a third voltage that is higher than the second voltage when the temperature of the plasma display is greater than the reference temperature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a configuration of a plasma display according to an exemplary embodiment of the present invention;

FIG. 2 is a flowchart representing an operation of a controller shown in FIG. 1;

FIG. 3 is a diagram representing a driving waveform caused by a normal control signal according to the exemplary embodiment of the present invention shown in FIG. 2;

FIG. 4 is a diagram representing a driving waveform caused by a high temperature control signal according to the exemplary embodiment of the present invention shown in FIG. 2;

FIG. 5 is a diagram representing a scan electrode driver according to the exemplary embodiment of the present invention;

FIG. 6 is a schematic diagram of a gate driving circuit of a transistor in the scan electrode driver shown in FIG. 5;

FIG. 7 is a diagram representing outputs of respective controls signals in the gate driving circuit shown in FIG. 6;

FIG. 8 is a diagram of a dV voltage generator according to a first exemplary embodiment of the present invention;

FIG. 9 is a diagram of a dV voltage generator according to a second exemplary embodiment of the present invention; and

FIG. 10 is a diagram representing a dV voltage generator according to a third exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the following detailed description, only certain exemplary embodiments of the present invention have been shown and described, simply for illustration. As those skilled in the art would realize, the described embodiments may be modified in various different ways, all without departing from the spirit or scope of the present invention. Accordingly, the drawings and description are to be regarded as illustrative in nature and not restrictive.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Throughout this specification and the claims that follow, the wall charge refers to a charge that is formed on a wall (for example, a dielectric layer) of the discharge cell close to the electrodes to be stored. Even though the wall charge is not actually in contact with the electrode, hereinafter, it may be described that the wall charge is formed, accumulated, or stacked on the electrode. Further, the wall voltage refers to a potential difference generated on the wall of the discharge cell by the wall charge.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

A plasma display according to an exemplary embodiment of the present invention, and a driver and a driving method thereof, will be described with reference to the figures.

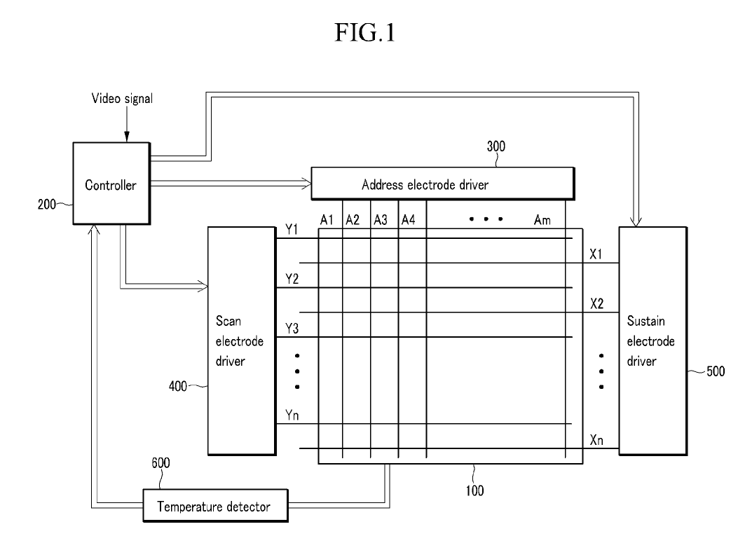

FIG. 1 is a schematic diagram of a configuration of the plasma display according to the exemplary embodiment of the present invention. As shown in FIG. 1, the plasma display according to the exemplary embodiment of the present invention includes a plasma display panel (PDP) 100, a controller 200, an address electrode driver 300, a scan electrode driver 400, a sustain electrode driver 500, and a temperature detector 600. The PDP 100 includes a plurality of address electrodes A1 to Am (hereinafter “A electrodes”) extending in a column direction, and a plurality of sustain electrodes X1 to Xn (hereinafter “X electrodes”) and a plurality of scan electrodes Y1 to Yn (hereinafter “Y electrodes”) extending in a row direction. The plurality of Y electrodes Y1 to Yn and X electrodes X1 to Xn are arranged so as to be arranged in pairs; however, aspects of the present invention are not limited thereto such that one or a number of the plurality of Y electrodes Y1 to Yn may be arranged to correspond to one or a number of the plurality of X electrodes X1 to Xn. Discharge cells 12 are formed at intersections of adjacent Y electrodes Y1 to Yn and X electrodes X1 to Xn, and the A electrodes A1 to Am.

The controller 200 receives a video signal from outside to output an address electrode driving control signal, a sustain electrode driving control signal, and a scan electrode driving control signal so as to divide one frame into a plurality of subfields respectively having weight values. In this case, the controller 200 receives information on a temperature of the PDP 100 and temperatures of peripheral devices from the temperature detector 600, and outputs the scan electrode driving control signal according to the received temperatures.

The address electrode driver 300 receives the address electrode driving control signal from the controller 200 to apply a signal for selecting a desired discharge cell to the A electrodes A1 to Am. The scan electrode driver 400 receives the scan electrode driving control signal from the controller 200 to apply a driving voltage to the Y electrodes Y1 to Yn, and the sustain electrode driver 500 receives the sustain electrode driving control signal from the controller 200 to apply the driving voltage to the X electrodes X1 to Xn.

The temperature detector 600 detects the temperature of the PDP 100 and the temperatures of the peripheral devices (i.e., the address electrode driver 300, the scan electrode driver 400, and the sustain electrode driver 500, but is not limited thereto), and transmits the temperatures to the controller 200. For convenience of description, it will be described that the temperature detector 600 detects a temperature of the plasma display, and in this case, the temperature of the plasma display includes the temperatures of the PDP 100 and/or the temperatures of the peripheral devices disposed adjacent to the PDP 100. In addition, the temperature detector 600 may measure the temperature of the plasma display by providing a sensor for sensing the temperature to an area of which temperature is measured, and detailed descriptions thereof will be omitted as they are well known to a person of ordinary skill in the art.

In addition, when the plasma display is driven, heat is generated on the PDP 100 and the adjacent drivers, i.e., the address electrode driver 300, the scan electrode driver 400, and the sustain electrode driver 500. Characteristics of semiconductor elements in the drivers 300, 400, and 500 vary, and therefore the driving voltage may not be generated according to the control signal generated by the controller 200. For example, to apply a reset falling waveform for gradually decreasing a voltage applied to the Y electrodes Y1 to Yn to a reset minimum voltage during a part of the reset period, the scan electrode driver 400 driver includes a lamp switch to selectively apply a predetermined current during the part of the reset period. Here, an n-channel field effect transistor that is turned on to selectively apply a current between a source and a drain of the transistor when a voltage difference between a gate voltage and a source voltage is increased to be greater than a threshold voltage is generally used as the lamp switch. In such case, when the temperature of the scan electrode driver 400 becomes a high temperature, the threshold voltage of the lamp switch varies, and therefore the slope of the reset falling waveform applied to the Y electrodes Y1-Yn becomes steeper. Accordingly, the wall charges may not be appropriately eliminated during the reset period so the controller 200 generates the control signal according to the detected temperatures of the PDP 100 and the peripheral devices.

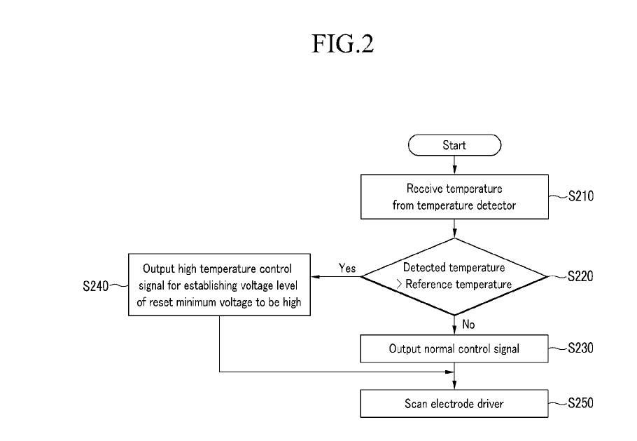

FIG. 2 is a flow chart representing an operation of the controller shown in FIG. 1. As shown in FIG. 2, the controller 200 receives the temperature of the plasma display that is detected by the temperature detector 600 in operation S210, and compares the temperature of the plasma display and a reference temperature in operation S220. In this case, when the temperature of the plasma display is less than the reference temperature (i.e., when the temperature of the plasma display is room temperature), the controller 200 outputs a normal control signal for establishing the reset minimum voltage to a room temperature voltage level in operation S230, i.e., the controller 200 outputs normal control signals.

However, when the temperature of the plasma display is greater than the reference temperature (i.e., when the temperature of the plasma display is at a high temperature), the controller 200 outputs a high temperature control signal to control the reset minimum voltage to be a high temperature reset minimum voltage that is higher than the room temperature reset minimum voltage in operation S240.

Accordingly, the control signal output from the controller 200 according to the detected temperature is input to the scan electrode driver 400 to control the reset falling waveform applied to the Y electrodes Y1 to Yn in operation S250.

In addition, the reference temperature in FIG. 2 is a temperature of the PDP 100 that causes the threshold voltage of the lamp switch of the scan electrode drive 400 to be varied so that the slope of the reset falling waveform may be steeper when the normal control signal is output from the controller 200, and it may be experimentally obtained.

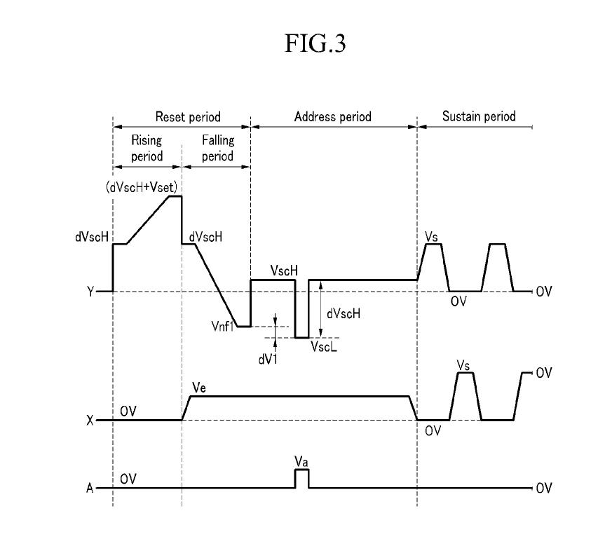

A driving waveform according to the exemplary embodiment of the present invention when the temperature of the PDP 100 detected by the temperature detector 600 is less than the reference temperature will be described with reference to FIG. 3. FIG. 3 is a diagram representing the driving waveform caused by the normal control signals of the controller 200 according to the exemplary embodiment of the present invention shown in FIG. 2, i.e., when the controller 200 outputs normal control signals). Further, the driving waveform of FIG. 3 is described with respect to one of each of the A electrodes A1-An, X electrodes X1-Xn, and Y electrodes Y1-Yn; however, it is understood that aspects of the present invention may be applied to all of the A electrodes A1-An, X electrodes X1-Xn, and Y electrodes Y1-Yn. Further, the A electrode, the X electrode, and the Y electrode correspond to a discharge cell of the PDP 100. FIG. 3 is not drawn to scale.

As shown in FIG. 3, during a rising period of the reset period, while a voltage applied to the A electrode and a voltage applied to the X electrode are respectively maintained at a reference voltage (0V in FIG. 3, and referred to as a “0V voltage”), a reset rising waveform for gradually increasing from a rising start voltage (dVscH in FIG. 3) to a reset maximum voltage ((dVscH+Vset) in FIG. 3) is applied to the Y electrode. Here, the reset maximum voltage dVscH+Vset is set sufficiently high so as to generate a discharge of each wall charge state in the corresponding discharge cells.

While the voltage at the Y electrode gradually increases during the rising period, a weak discharge (hereinafter referred to as a “reset discharge”) is generated between the Y electrode and the X electrode and between the Y electrode and the A electrode, (−) wall charges are formed on the Y electrode, and (+) wall charges are formed on the X electrode and the A electrode.

Subsequently, during the falling period, while the voltage at the A electrode and the voltage at the X electrode are respectively maintained at the 0V voltage and a bias voltage (Ve in FIG. 3), the reset falling waveform for gradually decreasing from a falling start voltage (dVscH in FIG. 3), which is a same voltage level as the rising start voltage dVscH, to a reset minimum voltage (Vnf1 in FIG. 3) is applied to the Y electrode. Here, the reset minimum voltage Vnf1 is established to be the room temperature voltage level according to the normal control signal output by the controller 200 when the temperature of the plasma display is less than the reference voltage.

During the falling period, while the voltage at the Y electrode gradually decreases, the reset discharge is generated between the Y electrode and the X electrode and between the Y electrode and the A electrode, and the (−) wall charges formed on the Y electrode and the (+) wall charges formed on the X electrode and the A electrode are eliminated.

As shown in FIG. 3, when the voltage at the Y electrode reaches the reset minimum voltage (Vnf1 in FIG. 3), the reset period is finished, and the address period is started.

During the address period, to select a turn-on cell, while the bias voltage Ve is applied to the X electrode, a scan voltage (VscL in FIG. 3) is selectively applied to the Y electrode which is selected among the plurality of Y electrodes. Here, the scan voltage VscL may be sequentially applied to the plurality of Y electrodes Y1 to Yn. In addition, an address voltage (Va in FIG. 3) is applied to the A electrode forming the discharge cell to be selected among the plurality of discharge cells in which the scan voltage VscL is applied to the Y electrode. Accordingly, an address discharge is generated between the A electrode receiving the address voltage Va and the Y electrode receiving the scan voltage VscL and between the Y electrode receiving the scan voltage VscL and the X electrode receiving the bias voltage Ve, the (+) wall charges are formed on the Y electrode, and the (−) wall charges are formed on the A electrode and the X electrode. In this case, a non-scan voltage (VscH in FIG. 3) that is higher than the scan voltage VscL is applied to the Y electrode to which the scan voltage VscL is not applied, and the 0V voltage is applied to the A electrode of a cell that is not selected. Further, the non-scan voltage VscH is applied to the Y electrode while the scan voltage VscL is not applied.

In addition, as shown in FIG. 3, as the scan voltage VscL is set to be lower than the reset minimum voltage Vnf1, a discharge delay of the address discharge may be reduced. Here, according to the control signal, the reset minimum voltage Vnf1 is set to be a sum of the scan voltage VscL and the dV1 voltage.

Subsequently, during the sustain period, since a sustain pulse of a sustain voltage (Vs in FIG. 3) and a sustain pulse of the 0V voltage are applied to the Y electrode and the X electrode in inverse phases, a sustain discharge is generated between the Y electrode and the X electrode. Specifically, while the sustain pulse having the sustain voltage Vs is applied to one of the Y and the X electrodes, the sustain pulse of the 0V voltage is applied to the other of the Y and the X electrodes. Then, an operation for applying the sustain pulse of the sustain voltage Vs to the Y electrode and an operation for applying the sustain pulse of the sustain voltage Vs to the X electrode are repeatedly performed a number of times corresponding to a weight value of the corresponding subfield. Here, the sustain voltage Vs is a discharge firing voltage Vs of the Y electrode and the X electrode.

In addition, while it has been described in FIG. 3 that the reset period includes a main reset period including the rising period and the falling period, the reset period may include an auxiliary reset period, including the falling period, to reduce background light. Here, the main reset period is for generating the reset discharge to eliminate the wall charges in each cell, but the auxiliary reset period is for generating the reset discharge to eliminate the wall charges in some cells.

In addition, in FIG. 3, it is illustrated that the rising start voltage and the falling start voltage are both the dVscH voltage, which corresponds to a voltage difference (VscH−VscL) between the scan voltage VscL and the non-scan voltage VscH. However, according to aspects of the present invention, the rising start voltage or the falling start voltage may be set to any voltage that is lower than the discharge firing voltage Vs of the X and Y electrodes.

When the plasma display device is driven, heat is generated by the discharge in the PDP 100, and heat is generated by the operation of each element of the drivers 300, 400, 500. The movement of the wall charges formed in each discharge cell becomes more active because of the heat generated in the PDP 100 and the peripheral devices, and operational characteristics of the field effect transistors in the drivers 300, 400, 500 may be varied.

Particularly, when the threshold voltage of the lamp switch of the scan electrode driver 400 operating to apply the reset falling waveform to the Y electrode during the falling period of the reset period is reduced by the high temperature, the slope of the reset falling waveform applied to the Y electrode becomes steeper. Accordingly, since the voltage difference between the X and Y electrodes and the voltage difference between the A and Y electrodes vary more quickly during the falling period at high temperatures, the reset discharge may be generated more strongly between the respective electrodes. As described, when the reset discharge is strongly generated, the wall charges are excessively eliminated, and a low discharge may be generated during the address period.

To prevent the low discharge caused by the high temperature of the PDP 100 when the plasma display is driven, the controller 200 generates the high temperature control signal when the temperature of the PDP 100 detected by the temperature detector 600 is greater than the reference temperature. In addition, the drivers 300, 400, 500 generate the driving waveforms according to the high temperature control signal generated by the controller 200.

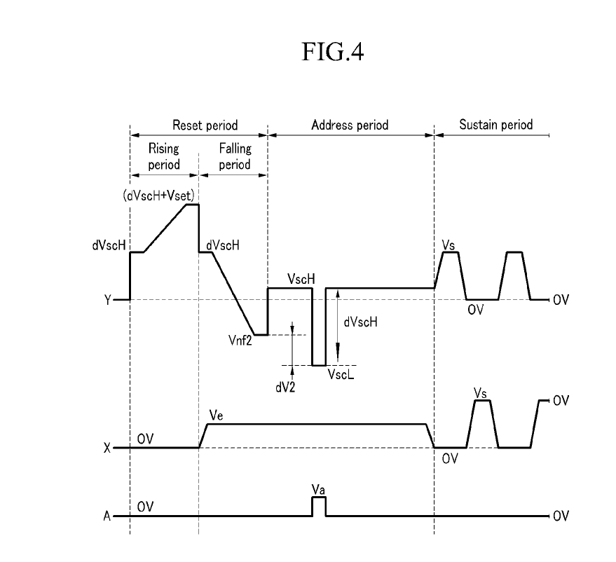

FIG. 4 is a diagram representing a driving waveform caused by the high temperature control signal generated by the controller 200, i.e., a driving waveform applied when the controller 200 determines that the temperature of the PDP 100, as detected by the temperature detector 600, is greater than the reference temperature, according to the exemplary embodiment of the present invention in FIG. 2. The driving waveform of the plasma display caused by the high temperature control signal shown in FIG. 4 is the same as that according to the normal control signal shown in FIG. 3 except that a high temperature falling minimum voltage Vnf2 is higher than the room temperature falling minimum voltage Vnf1 of FIG. 3; thus, parts having already been described will be omitted. Further, the driving waveform of FIG. 4 is described with respect to one of each of the A electrodes A1-An, X electrodes X1-Xn, and Y electrodes Y1-Yn; however, it is understood that aspects of the present invention may be applied to all of the A electrodes A1-An, X electrodes X1-Xn, and Y electrodes Y1-Yn.

As shown in FIG. 4, according to the driving waveform of the plasma display in response to the high temperature control signal from the controller 200, while the voltage at the A electrode and the voltage at the X electrode are maintained at the 0V voltage during the rising period of the reset period, the voltage at the Y electrode is gradually increased from the rising start voltage (dVscH in FIG. 4) to the reset maximum voltage ((dVscH+Vset) in FIG. 4). Thereby, while the voltage at the Y electrode is gradually increased, the reset discharge is generated between the Y electrode and the X electrode and between the Y electrode and the A electrode, the (−) wall charges are formed on the Y electrode, and the (+) wall charges are formed on the X electrode and the A electrode.

Subsequently, during the falling period of the reset period, while the voltage at the A electrode and the voltage at the X electrode are respectively maintained at the 0V voltage and the bias voltage Ve, the voltage at the Y electrode is gradually decreased from the falling start voltage (dVscH in FIG. 4) to the reset minimum voltage (Vnf2 in FIG. 4). As described above, while the voltage at the Y electrode is gradually decreased during the falling period, the reset discharge is generated between the Y electrode and the X electrode and between the Y electrode and the A electrode, and the (−) wall charges formed on the Y electrode and the (+) wall charges formed on the X electrode and the A electrode are eliminated.

In this case, the reset minimum voltage Vnf2 is established as the high temperature voltage level according to the high temperature control signal from the controller 200 and is higher than the reset minimum voltage Vnf1 of the normal control signal. In addition, according to the exemplary embodiment of the present invention, when the voltage at the Y electrode is reduced to the reset minimum voltage Vnf2, the reset period is finished, and the address period is started.

Also, when the temperature of the PDP 100 reaches such a high temperature, the operational characteristic of the lamp switch of the scan electrode driver 400 for applying the reset falling waveform to the Y electrode varies, and therefore the slope of the reset falling waveform is steeper than the slope of the reset falling waveform at room temperature. Further, the wall charges respectively formed on the X electrode, the A electrode, and the Y electrode and space charges in the cell become more active due to the heat. Accordingly, the reset discharge may be generated too strongly between the X and Y electrodes and between the A and Y electrodes compared to the reset discharge at room temperature.

According to the driving waveform of the conventional plasma display device, the reset period is established as a predetermined time, the reset falling waveform is applied to the Y electrode and the minimum reset voltage is maintained at the Y from a time when the voltage at the Y electrode is decreased to the reset minimum voltage to a time when the reset period is finished. In such case, since the reset discharge is continuously generated during a period for maintaining the reset minimum voltage at the Y electrode, the wall charges formed on the respective electrodes are eliminated.

However, because the slope of the reset falling waveform varies according to the temperature of the PDP, the period for maintaining the reset minimum voltage at the Y electrode also varies. That is, because the period in which the reset minimum voltage is maintained at the Y electrode is increased, the wall charges may be excessively eliminated before the reset period is finished when the temperature of the PDP is the high temperature, thereby resulting in the low discharge being generated during the address period.

According to aspects of the present invention, the reset period is finished at a time when the voltage at the Y electrode is reduced to the reset minimum voltage Vnf1 or Vnf2, and the reset minimum voltage level Vnf2 is set to be higher than the reset minimum voltage Vnf1 when the temperature of the PDP 100 is the higher than a reference temperature. Thereby, the reset discharge at the high temperature is generated to be shorter than the reset discharge at room temperature, and therefore the wall charges in the discharge cell may be prevented from being excessively eliminated.

Subsequently, to select a turn-on cell during the address period, while the bias voltage Ve is applied to the X electrode, the scan voltage VscL is selectively applied to at least one of the plurality of Y electrodes Y1 to Yn, and the address voltage Va is applied to the A electrode to select a discharge cell from the cells corresponding to the Y electrodes to which the scan voltage VscL is applied. Accordingly, the address voltage Va is applied to the A electrode, the address discharge is generated in the discharge cell in which the scan voltage VscL is applied to the Y electrode, the (+) wall charges are formed on the Y electrode, and the (−) wall charges are formed on the A electrode and the X electrode. Here, a non-scan voltage VscH is applied to the Y electrode to which the VscL voltage is not applied, and the 0V voltage is applied to the A electrode forming the cell that is not selected. Further, the non-scan voltage VscH is applied to the Y electrode while the scan voltage VscL is not applied.

According to aspects of the present invention, the reset minimum voltage Vnf2 is higher than the reset minimum voltage Vnf1 when the temperature of the PDP 100 is a temperature higher than a reference temperature. That is, when the temperature of the PDP 100 is room temperature (i.e., below the reference temperature), the reset minimum voltage Vnf1, corresponding to a sum of the scan voltage VscL and the dV1 voltage, is applied to the Y electrode. And, when the temperature of the PDP 100 is greater than the reference temperature, the reset minimum voltage Vnf2, corresponding to a sum of the scan voltage VscL and the dV2 voltage, is applied to the Y electrode.

Thus, when the voltage difference dV2 between the scan voltage VscL and the reset minimum voltage Vnf2 at the high temperature is higher than the voltage difference dV1 at room temperature, the PDP 100 may prevent the wall charges from being excessively eliminated due to the high temperature; and therefore, the generation of a low discharge during the address period may be decreased.

Descriptions of the address period and the sustain period in the driving waveform of the plasma display according to the high temperature control signal shown in FIG. 4 are the same as in the driving waveform according to the normal control signal shown in FIG. 3, and therefore parts having already been described will be omitted. It should be noted that FIGS. 3 and 4 are not drawn to scale.

In FIG. 3 and FIG. 4, while it has been described that the reset rising waveform or the reset falling waveform is formed in a ramp waveform type, aspects of the present invention are not limited thereto such that another waveform that gradually decreases or gradually increases (e.g., an RC waveform and a waveform that floats while gradually increasing or decreasing) may be applied.

As described above, according to aspects of the present invention, the reset period is finished when the voltage at the Y electrode reaches the reset minimum voltage Vnf1 or Vnf2, and then the address period is started. In addition, when the temperature of the PDP 100 is greater than the reference temperature, the reset minimum voltage level (i.e., Vnf2) is increased compared to when the temperature of PDP 100 is less than the reference temperature, i.e., when the reset minimum voltage level Vnf1 is applied to the Y electrode. Thus, a time for generating the reset discharge may be reduced when the temperature of the PDP 100 is higher than the reference temperature, the voltage difference dV2 between the reset minimum voltage Vnf2 and the scan voltage VscL may be higher, and the low discharge during the address period may be decreased.

Hereinafter, the driver of the plasma display for generating the driving waveform according to the normal control signal and the high temperature control signal will be described.

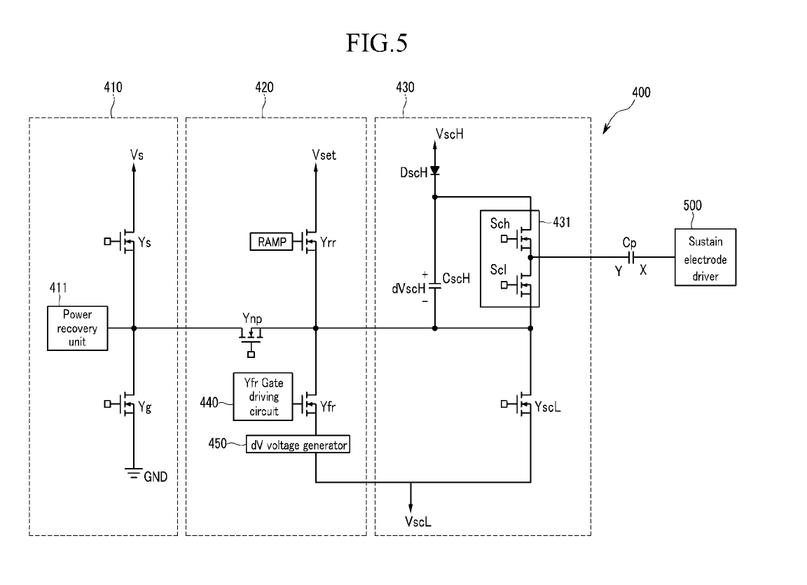

FIG. 5 is a diagram representing the scan electrode driver 400 according to aspects of the present invention. In FIG. 5, while the switch is illustrated as an n-channel field effect transistor (FET), this is only an example, and another element for performing a function that is the same as or similar to that of the n-channel FET may be used as the transistor according to aspects of the present invention. In addition, a capacitive component formed by the X and Y electrodes is described as a panel capacitor Cp.

As shown in FIG. 5, the scan electrode driver 400 according to the exemplary embodiment of the present invention includes a sustain driver 410, a reset driver 420, and a scan driver 430.

The sustain driver 410 includes a power recovery unit 411, a transistor Ys, and a transistor Yg, and the power recovery unit 411 alternately applies a sustain voltage Vs and the 0V voltage to the Y electrode during the sustain period.

While not shown in FIG. 5, the power recovery unit 411 includes a power recovery capacitor, a power recovery inductor, a rising path forming transistor, and a falling path forming transistor. Here, the power recovery capacitor is charged with a voltage between the sustain voltage Vs and the 0V voltage (e.g., a Vs/2 voltage)

In the power recovery unit 411, when the rising path or falling path forming transistor is turned on, an inductor capacitor resonance current path is formed between the power recovery capacitor, the power recovery inductor, and the panel capacitor Cp, and a voltage of the panel capacitor Cp is increased or decreased. Since the power recovery unit 411 is not directly related to the aspects of the present invention, detailed descriptions thereof will be omitted.

A drain of the transistor Ys is connected to a power source Vs for supplying the Vs voltage, a source of the transistor Ys is coupled to a drain of a transistor Ynp, and the transistor Ys is turned on during the sustain period to apply the Vs voltage to the Y electrode. In addition, a source of the transistor Yg is coupled to a power source GND for supplying the 0V voltage, a drain thereof is coupled to a drain of the transistor Ynp, and the transistor Yg is turned on during the sustain period to apply the 0V voltage to the Y electrodes Y1 to Yn.

The reset driver 420 includes transistors Yrr, Ynp, and Yfr, and a dV voltage generator 450, and the reset driver 420 applies the reset rising waveform and the reset falling waveform to the Y electrode during the reset period.

As shown in FIG. 5, a drain of a transistor Yrr is connected to a power source Vset for supplying a Vset voltage, and a source of the transistor Yrr is connected to a source of the transistor Ynp. During the rising period of the reset period, when the transistor Yrr is turned on, a source voltage of the transistor Ynp is gradually increased to the Vset voltage.

A drain of the transistor Yfr is connected to the source of the transistor Ynp. The dV voltage generator 450 is connected between a source of the transistor Yfr and a power source VscL for supplying a scan voltage VscL.

Without including an additional power source for supplying the reset minimum voltage Vnf, the plasma display according to aspects of the present invention generates the reset minimum voltage Vnf corresponding to a sum of the VscL voltage and a predetermined voltage (the dV1 voltage or the dV2 voltage, according to a detected temperature of the PDP 100) by using the power source for supplying the VscL voltage and the dV voltage generator 450. In this case, the dV voltage generator 450 may generate voltages respectively having different voltage levels (e.g., the dV1 voltage or the dV2 voltage) by using a variable resistor having resistance that varies according to the control signal of the controller 200 of FIG. 1. That is, the dV voltage generator 450 generates the dV1 voltage according to the normal control signal when the temperature of the PDP 100 is room temperature (i.e., when the temperature of the PDP 100 is less than a reference temperature), and the dV voltage generator 450 generates the dV2 voltage according to the high temperature control signal when the temperature of the PDP 100 is the high temperature (i.e., when the temperature of the PDP 100 is greater than a reference temperature). According to aspects of the present invention, the dV voltage generator 450 may generate one of the dV1 voltage and the dV2 voltage when the temperature of the PDP 100 is equal to the reference temperature depending upon how the reference temperature is determined.

During the falling period of the reset period, when the transistor Yfr is turned on, a source voltage of the transistor Ynp is gradually decreased to the reset minimum voltage Vnf corresponding to a sum of the VscL voltage and the voltage generated by the dV voltage generator 450. In this case, the reset minimum voltage is set to be the reset minimum voltage Vnf1 corresponding to a sum of the VscL voltage and the dV1 voltage generated by the dV voltage generator 450 when the temperature of the PDP 100 is below the reference temperature, and the reset minimum voltage Vnf2 corresponding to a sum of the VscL voltage and the dV2 voltage when the temperature of the PDP 100 is higher than the reference temperature.

In addition, since the transistor Yg includes a body diode including a cathode connected to the drain of the transistor Yg and an anode connected to the source of the transistor Yg, a current may flow from the power source GND to the power source VscL while applying the VscL voltage or the reset minimum voltage that is lower than the 0V voltage to the Y electrode. Accordingly, as shown in FIG. 5, the transistor Ynp including the drain connected to the source of the transistor Ys and the drain of the transistor Yg, and the source connected to the source of the transistor Yrr and the drain of the transistor Yfr, is further provided. Thereby, the transistor Ynp is turned off, and the voltage that is lower than the OV voltage may be applied to the Y electrodes Y1 to Yn.

The scan driver 430 includes a diode DscH, a capacitor CscH, a transistor YscL, and a selection circuit 431. In addition, the scan driver 430 sequentially applies the VscL voltage to the Y electrodes Y1 to Yn, and applies the VscH voltage to at least one Y electrode to which the VscL voltage is not applied.

A source of the transistor YscL is connected to the power source VscL, a drain thereof is connected to the source of the transistor Ynp, and the transistor YscL is turned on during the address period to maintain the source voltage of the transistor Ynp at a scan voltage VscL.

A first terminal of the capacitor CscH is connected to the source of the transistor Ynp, a second terminal thereof is connected to a cathode of the diode DscH, and an anode of the diode DscH is coupled to the power source for supplying a non-scan voltage VscH. The diode DscH prevents a current path including the power source VscH from being generated while a voltage that is lower than the non-scan voltage VscH is applied to the Y electrodes Y1 to Yn. In addition, the capacitor CscH is charged with the dVscH voltage corresponding to a voltage difference (VscH−VscL) between the non-scan voltage VscH and the scan voltage VscL by turning on the transistor YscL when the plasma display is initially driven.

The selection circuit 431 includes a transistor Sch and a transistor Scl. A drain of the transistor Sch is coupled to the second terminal of the capacitor CscH and a source thereof is coupled to the Y electrode. A source of the transistor Scl is coupled to the drain of the transistor YscL, and a drain thereof is coupled to the Y electrode. In FIG. 4, while the selection circuit 431 connected to one Y electrode is only illustrated, the selection circuit is coupled to each of the plurality of Y electrodes Y1 to Yn, and generally, a plurality of the selection circuits 431 is formed as an integrated circuit.

In addition, according to the driving waveforms shown in FIG. 3 and FIG. 4 according to aspects of the present invention, when the voltage at the Y electrode reaches the reset minimum voltage Vnf, the falling period is finished, and the address period is started. A gate driving circuit 440 for applying a driving voltage to a gate of the transistor Yfr operating to apply the reset falling waveform to the Y electrode during the falling period of the reset period will now be described.

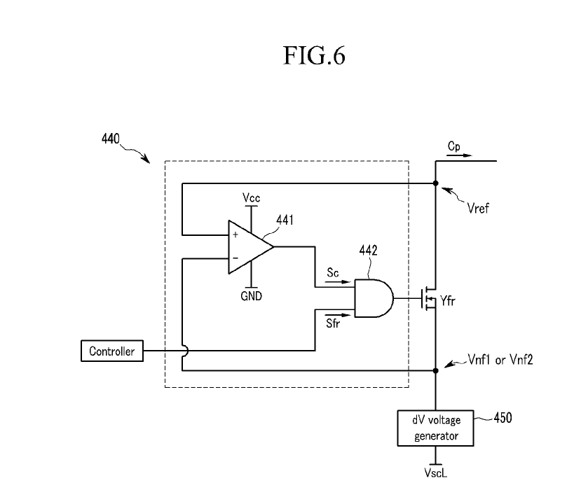

FIG. 6 is a schematic diagram of the gate driving circuit 440 of the transistor Yfr in the scan electrode driver 400 shown in FIG. 5. The gate driving circuit 440 is connected to the gate of the transistor Yfr to turn on the transistor Yfr so that the reset falling waveform for gradually decreasing to the reset minimum voltage (Vnf1 or Vnf2 in FIG. 6) may be applied to the Y electrode during the falling period of the reset period. In addition, during the falling period of the reset period, it is determined whether the voltage at the Y electrode is less than the reset minimum voltage Vnf1 or Vnf2 from FIGS. 3 and 4, respectively, and the transistor Yfr is turned off when the voltage at the Y electrode is less than the reset minimum voltage Vnf1 or Vnf2.

As shown in FIG. 6, the gate driving circuit 440 of the transistor Yfr includes a comparator 441 and an AND element 442. The comparator 441 includes a non-inverting input terminal coupled to the drain of the transistor Yfr and an inverting input terminal coupled to the source of the transistor Yfr. The AND element 442 includes a first input terminal coupled to an output terminal of the comparator 441, a second input terminal coupled to the controller 200 to which a turn-on-turn-off control signal Sfr of the transistor Yfr is output, and an output terminal coupled to the gate of the transistor Yfr.

In addition, during the falling period of the reset period, the transistor Yfr is turned on to apply the reset falling waveform to the Y electrode. Here, a falling current path of the power source VscL, the dV voltage generator, the transistor Yfr, the transistor Scl of the selection circuit 431, and the Y electrode of the panel capacitor Cp is generated when the transistor Yfr is turned on, and the voltage at the Y electrode is gradually decreased since a predetermined current flows through the falling current path. In this case, when the voltage at the Y electrode reaches the reset minimum voltage Vnf, the transistor Yfr is turned off, the reset period is finished, and the address period is started.

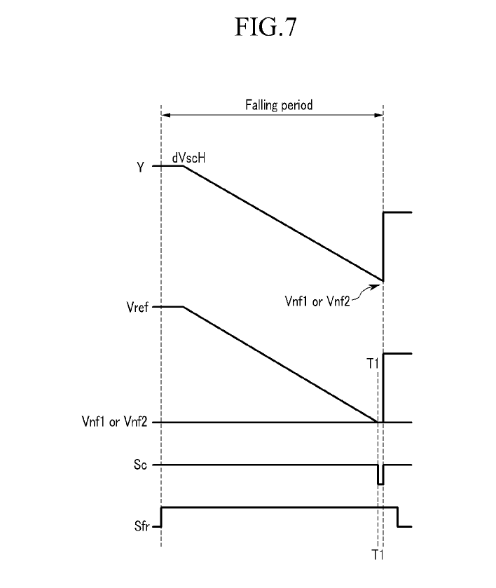

An operation for turning off the transistor Yfr in the gate driving circuit 440 when the voltage at the Y electrode reaches the reset minimum voltage Vnf will be described with reference to FIG. 7.

FIG. 7 is a diagram representing outputs of respective control signals in the gate driving circuit 440 shown in FIG. 6. As shown in FIG. 6, the reset minimum voltage Vnf1 or Vnf 2 corresponding to a sum of the scan voltage VscL supplied from the power source VscL and the voltage generated by the dV voltage generator is applied to the inverting input terminal of the comparator 441 of the gate driving circuit 441, and the Y electrode voltage (Vref in FIG. 6 and referred to as a “Vref voltage”) decreasing by the operation of the transistor Yfr is applied to the non-inverting input terminal of the comparator 441. The comparator 441 compares voltages respectively input to the non-inverting input terminal and the inverting input terminal. When the Vref voltage applied to the non-inverting input terminal is higher than the reset minimum voltage Vnf1 or Vnf2 applied to the inverting input terminal, an output signal (Sc in FIG. 6 and referred to as an “Sc signal”) of the output terminal of the comparator 441 is applied at a high level (hereinafter referred to as “1”). In addition, when the Vref voltage is the reset minimum voltage Vnf1 or Vnf2, the Sc signal becomes a low level (hereinafter referred to as “0”).

During the falling period, while the voltage at the Y electrode is gradually decreased, the Vref voltage is higher than the reset minimum voltage Vnf1 or Vnf2, and therefore the Sc signal applied to the first input terminal of the AND element 442 is 1. In addition, since it is required to turn of the transistor Yfr during the falling period, the turn-on-turn-off control signal (Sfr in FIG. 6b and referred to as a “Sfr signal”) of the transistor Yfr that is generated by the controller 200 is set to be 1. Thereby, since 1 is applied to the first and second input terminals of the AND element 442, 1 is output to the output terminal of the AND element 442, and a voltage for turning on the transistor Yfr is applied to the gate of the transistor Yfr.

In addition, the Vref voltage and the reset minimum voltage become the same at a time T1 in FIG. 7 when the voltage at the Y electrode reaches the reset minimum voltage Vnf1 or Vnf2 while the voltage at the Y electrode is gradually decreased, and therefore, the Sc signal applied to the first input terminal of the AND element 442 becomes 0. The AND element 442 outputs 1 through the output terminal when 1 is commonly applied to the first input terminal and the second input terminal. Accordingly, when 0 is applied to the first input terminal of the AND element 442, 0 is applied to the output terminal of the AND element 442, and a voltage for turning off the transistor Yfr is applied to the gate of the transistor Yfr.

Referring back to FIGS. 3 and 4, when the reset minimum voltage Vnf1 or Vnf2 is applied to the Y electrode while the voltage at the Y electrode is gradually decreased during the falling period, the reset period is finished, and the address period is started. As described, to generate the driving waveform, when the Sc signal is 0, the gate driving circuit of the transistor YscL applies a voltage for turning on the transistor YscL to a gate of the transistor YscL. That is, the non-scan voltage VscH or the scan voltage VscL is respectively applied to the plurality of Y electrodes Y1 to Yn by turning on the transistor YscL at the same time when the transistor Yfr is turned off.

Further, in FIG. 6 and FIG. 7, the “1 signal” may be set as a driving voltage of the transistor Yfr, the “0 signal” may be set as the 0V voltage, and the “1 signal” and the “0 signal” may be set as respective voltages having different levels.

As described, according to the exemplary embodiment of the present invention, the gate driving circuit connected to the gate of the transistor Yfr compares the voltage at the Y electrode and the reset minimum voltage Vnf1 or Vnf2 during the falling period of the reset period, and applies the voltage for turning off the transistor Yfr to the gate of the transistor Yfr when the voltage at the Y electrode reaches the reset minimum voltage Vnf1 or Vnf2. Thereby, since the period for maintaining the voltage at the Y electrode to be the reset minimum voltage during the reset period may be eliminated, the low discharge during the address period may be prevented regardless of the temperature of the PDP.

In addition, according to the exemplary embodiment of the present invention, the dV2 voltage is set to be higher than the dV1 voltage so that the address discharge may be stably generated during the address period regardless of the temperature of the PDP. That is, a voltage difference (dV1) between the reset minimum voltage Vnf1 and the scan voltage VscL when the temperature of the PDP is less than the reference temperature is set to be less than the voltage difference (dV2) between the reset minimum voltage Vnf2 and the scan voltage VscL when the temperature of the PDP is higher than the reference temperature. By the control signal of the controller 200 according to the temperature of the PDP, the dV voltage generator 450 connected between the power source VscL and the transistor YscL respectively generates the dV1 voltage and the dV2 voltage that have different voltage levels.

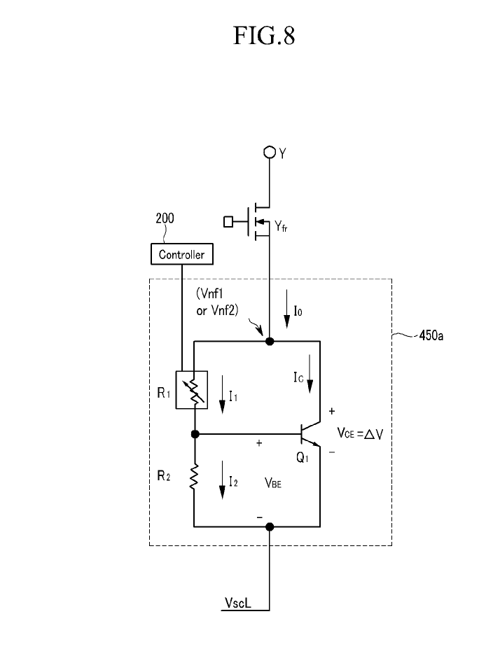

An operation and a configuration of the dV voltage generator 450 will be described with reference to FIGS. 8 to 10. FIG. 8 is a diagram of a dV voltage generator 450a according to an exemplary embodiment of the present invention. The dV voltage generator 450a includes a transistor Q1 and resistors R1 and R2. Here, the transistor Q1 is a bipolar transistor, and at least one of the resistor R1 and the resistor R2 is a variable transistor having a resistance that varies according to the control signal of the controller 200. While only the resistor R1 is illustrated as the variable transistor in FIG. 8 to simplify the explanation of the dV voltage generator 450a, such is not limited thereto, and various modifications may be applied (e.g., only the resistor R2 is set as the variable resistor, and the resistors R1 and R2 are both variable resistors).

A collector of the transistor Q1 is coupled to the source of the transistor Yfr and an emitter of the transistor Q1 is coupled to the power source VscL. The drain of the transistor Tfr is coupled to the Y electrode. A terminal of the resistor R1 is coupled to the collector of the transistor Q1, and another terminal of the resistor R1 is coupled to a base of the transistor Q1. A terminal of the resistor R2 is coupled to the base of the transistor Q1, and another terminal of the resistor R2 is coupled to the emitter of the transistor Q1. In addition, the resistor R1 and the resistor R2 are coupled to each other, and a node between the resistors R1 and R2 is coupled to the base of the transistor Q1.

When a current lo has a low value, the transistor Q1 is turned off so that the current I₀ flows through the resistors R1 and R2. However, when the current I₀ has a high value to turn on the transistor Q1, the current I₀ may flow to the transistor Q1 in addition to the resistors R1 and R2. When the transistor Q1 is on, a collector-emitter voltage V_{CE} of the transistor Q1 is described by Equation 1.

V_{CE}=I₁*R1+I₂*R2 [Equation 1]

When a base current of the transistor Q1 is not considered in Equation 1, then current I₁ is approximately equal to current ≈I₂, i.e., I₁≈I₂. Further, the current 12 is described by I₂=V_{BE}/R₂. Accordingly, the collector-emitter voltage V_{CE} of the transistor Q1 is given as Equation 2.

V_{CE}=(1+R₁/R₂)*V_{BE} [Equation 2]

Here, the collector-emitter voltage V_{CE} of the transistor Q1 is the dV voltage generated by the dV voltage generator 450a. Referring to Equation 2, the collector-emitter voltage (V_{CE}=dV) of the transistor Q1 is set to be a desired value in proportion to a base-emitter voltage V_{BE} of the transistor Q1 when a ratio of sizes of the resistors R1 and R2 is adjusted.

That is, the dV voltage generator 450a according to the first exemplary embodiment of the present invention may generate the dV voltage given as Equation 2, and the dV voltage is determined by the resistances of the resistors R1 and R2 and the value of the base-emitter voltage V_{BE} of the transistor Q1. When a value of the base-emitter voltage V_{BE} of the transistor Q1 is a value that is previously determined according to characteristics of the transistor Q1, a desired dV voltage may be set by varying the values of the resistors R1 and R2.

According to aspects of the present invention, the dV voltage generator 450a generates the dV1 voltage or the dV2 voltage according to the temperature of the PDP. Here, as the dV1 voltage is set to be less than the dV2 voltage, the value of the resistors R1 and R2 when the dV1 voltage is generated is set to be less than that when the dV2 voltage is generated. For example, as shown in FIG. 8, when the resistor R1 is the variable resistor, the controller sets the resistance of the resistor R1 when the temperature of the PDP is higher than the reference temperature to be higher than the resistance of the resistor R1 when the temperature of the PDP is not higher than the reference temperature. Thereby, the initialization of the wall charges may be appropriately performed during the reset period regardless of the temperature of the PDP, and problems associated with the low discharge may be decreased.

While it has been described that the transistor Q1 is a bipolar transistor, a metal-oxide semiconductor field effect transistor (MOSFET) or an insulated gate bipolar transistor (IGBT) may be used as the transistor Q1 according to aspects of the present invention.

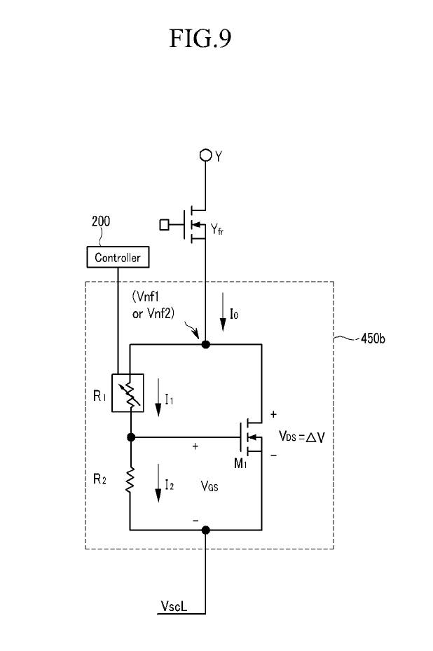

FIG. 9 is a diagram of a dV voltage generator 450b according to an exemplary embodiment of the present invention. As shown in FIG. 9, the dV voltage generator 450b is the same as that of the first exemplary embodiment of the present invention except that the MOSFET is used as a transistor M1, and therefore parts having already been described will be omitted.

Since the dV voltage generator 450b uses the MOSFET as the transistor M1, a drain-source voltage V_{DS} of the transistor M1 generated as the dV voltage is given as Equation 3.

V_{DS}=(1+R1/R2)*V_{GS} [Equation 3]

Here, V_{GS} denotes the gate-source voltage of the transistor M1. As shown in Equation 3, when the transistor M1 is the MOSFET, the gate-source voltage V_{GS} of the transistor M1 is substituted for the base-emitter voltage V_{BE} of the transistor Q1 shown in Equation 2.

As described above, in the dV voltage generator 450b, the dV voltage is adjusted by the gate-source voltage V_{GS} of the transistor M1 and the values of the resistors R1 and R2 as given in Equation 3.

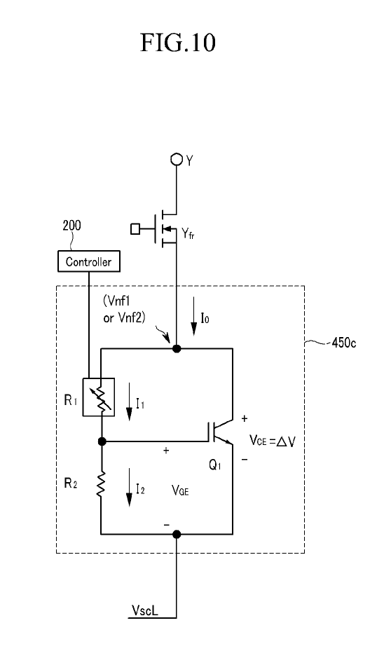

FIG. 10 is a diagram representing a dV voltage generator 450c according to an exemplary embodiment of the present invention. As shown in FIG. 10, the dV voltage generator 450c is the same as the dV voltage generator 450a except that the IGBT is used as a transistor Z1, and therefore parts having already been described will be omitted.

Differing from the dV voltage generator 450a, the dV voltage generator 450c uses the IGBT as the transistor Z1, and the collector-emitter voltage V_{CE} of the transistor Z1 which is the dV voltage is given as Equation 4.

V_{CE}=(1+R1/R2)*V_{GE} [Equation 4]

Here, V_{GE} denotes a gate-emitter voltage of the transistor Z1. When the transistor Z1 is the IGBR as shown in FIG. 10, the gate-emitter voltage V_{GE} of the transistor Z1 is substituted for the base-emitter voltage V_{BE} of the transistor Q1 in Equation 2.

As described above, the dV voltage is adjusted by the gate-emitter voltage V_{GE} of the transistor Z1 and the values of the resistors R1 and R2 in the dV voltage generator 450c.

In FIGS. 8 to 10, it is illustrated that the reset minimum voltage Vnf may be differently set according to the ratio of the values of the resistors R1 and R2 of which at least one is a variable resistance resistor controlled by the controller according to the temperature of the PDP 100.

As described, since the dV voltage is generated by the dV voltage generators 450a, 450b, and 450c according to aspects of the present invention, the VscL voltage and the reset minimum voltage Vnf may be generated by using one power source (VscL). In addition, since at least one of the resistor R1 and resistor R2 is formed as a variable resistor the resistance of which may be varied by an operation of the controller 200, the dV voltage may be adjusted by using the ratio of the values of the resistors R1 and R2. Accordingly, the voltage level of the reset minimum voltage Vnf may be varied according to the temperature of the PDP, and the problem of the low discharge may be decreased.

According to aspects of the present invention, as the reset period is finished when the voltage at the scan electrode reaches the reset minimum voltage, the initialization of the wall charges may be appropriately performed during the reset period. In addition, the voltage level of the reset minimum voltage may be varied by varying the ratio of the values of the resistors R1 and R2 according to the temperature of the PDP. Accordingly, the low discharge may be efficiently prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display, comprising:
a plasma display panel (PDP) comprising a plurality of first electrodes;
a controller to generate a control signal to display an externally input video signal on the plasma display panel;
a driver to respectively apply a driving voltage to each of the plurality of first electrodes according to the control signal generated by the controller; and
a temperature detector to detect a temperature of the PDP or a temperature of the driver,
wherein the controller generates a first control signal for gradually decreasing a voltage respectively applied to each of the plurality of first electrodes to a first voltage during a falling period of a reset period, the first voltage being higher than a scan voltage respectively applied to each of the plurality of first electrodes respectively applied to the each of the plurality of first electrodes during an address period, when the temperature transmitted from the temperature detector is less than a reference temperature, and the controller generates a second control signal for gradually decreasing the voltage respectively applied to each of the plurality of first electrodes to a second voltage that is higher than the first voltage during the falling period of the reset period when the temperature transmitted from the temperature detector is greater than the reference temperature, and
the driver comprises:
a first transistor respectively coupled to each of the plurality of first electrodes,
a first power source to supply the scan voltage during the address period and is turned on during the falling part of the reset period to gradually decrease the voltage respectively applied to each of the plurality of first electrodes, and
a gate driving circuit respectively coupled to a control terminal of the first transistor to respectively turn on the first transistor during the falling period of the reset period, to respectively turn off the first transistor at a time when the voltage respectively applied to each of the plurality of first electrodes is decreased to the first voltage if the first control signal is received from the controller, and to respectively turn off the first transistor at a time when the voltage respectively applied to each of the plurality of first electrodes is decreased to the second voltage if the second control signal is received from the controller.

2. The plasma display of claim 1, wherein the driver further comprises:
a voltage generator coupled between the first transistor and the first power source, the voltage generator generates a third voltage corresponding to a first voltage difference between the scan voltage and the first voltage when receiving the first control signal from the controller, and the voltage generator generates a fourth voltage corresponding to a second voltage difference between the scan voltage and the second voltage when receiving the second control signal from the controller.

3. The plasma display of claim 2, wherein the voltage generator comprises:
a third transistor including a first terminal coupled to a source of the first transistor and a second terminal coupled to the first power source;
a first resistor coupled between a control terminal of the third transistor and the first terminal of the third transistor; and
a second resistor coupled between the control terminal of the third transistor and the second terminal of the third transistor,
wherein at least one of the first resistor and the second resistor is a variable resistor having a resistance that varies according to an operation of the controller.

4. The plasma display of claim 3, wherein the resistance of the variable resistor is such that a ratio of the resistance of the first resistor to the resistance of the second resistor is a first ratio when receiving the first control signal from the controller, and the resistance variable resistor is such that the ratio of the resistance of the first resistor to the resistance of the second resistor is a second ratio that is greater than the first ratio.

5. The plasma display of claim 2, wherein the gate driving circuit coupled to the first transistor comprises:
a comparator having a first input terminal coupled to the plurality of first electrodes and a second input terminal coupled to a node of the first transistor and the voltage generator, the comparator outputting a first signal through an output terminal of the comparator when a voltage applied to the first input terminal is not the same as a voltage applied to the second input terminal, and the comparator outputting a second signal that is different from the first signal through the output terminal of the comparator when the voltage applied to the first input terminal is the same as the voltage applied to the second input terminal; and
a logic element having a first input terminal coupled to the output terminal of the comparator and a second input terminal coupled to the controller, the logic element applying a logic control signal to the first transistor generated by the controller to the second input terminal, and applying an AND operation result of signals respectively applied to the first and second input terminals to the output terminal of the logic element.

6. The plasma display of claim 5, wherein, in the gate driving circuit coupled to the first transistor, the first voltage is applied to the second input terminal of the comparator when the first control signal is received from the controller, and the second voltage is applied to the second input terminal of the comparator when the second control signal is received from the controller.

7. The plasma display of claim 6, wherein, in the gate driving circuit coupled to the first transistor, the first signal is applied to the first input terminal of the logic element, and a voltage for turning on the first transistor is applied to the output terminal of the logic element when a control signal for turning on the first transistor is applied to the second input terminal of the logic element.

8. The plasma display of claim 7, wherein, in the gate driving circuit coupled to the first transistor, a voltage for turning off the first transistor is output to the output terminal of the logic element when the second signal is applied to the first input terminal of the logic element or when a control signal for turning off the first transistor is applied to the second input terminal of the logic element.

9. The plasma display of claim 8, wherein the driver further comprises a second transistor coupled between the first power source and the plurality of first electrodes, the second transistor is turned on during the address period and turned on when the second signal is applied to the first input terminal of the logic element in the gate driving circuit coupled to the first transistor.

10. A driving device for driving a plasma display comprising a plurality of scan electrodes, the driving device comprising:
a temperature detector to detect a temperature of the plasma display;
a first transistor coupled between a first power source, the first power source to supply a scan voltage selectively applied to the scan electrode selected from the plurality of scan electrodes during an address period, and the plurality of scan electrodes;
a voltage generator coupled between the first power source and the plurality of scan electrodes, the voltage generator generating a first voltage when the temperature detected by the temperature detector is less than a reference temperature, and the voltage generator generating a second voltage that is higher than the first voltage when the temperature detected by the temperature detector is greater than the reference temperature;
a second transistor coupled between the voltage generator and the plurality of scan electrodes, the second transistor being driven to apply a voltage waveform gradually decreasing to a third voltage corresponding to a sum of the scan voltage and the first voltage to the plurality of scan electrodes when the temperature detected by the temperature detector is less than the reference temperature, and the second transistor being driven to apply the voltage waveform gradually decreasing to a fourth voltage corresponding to a sum of the scan voltage and the second voltage to the plurality of scan electrodes when the temperature detected by the temperature detector is greater than the reference temperature; and
a gate driving circuit of the second transistor, the gate driving circuit to apply a turn-off control signal to a gate of the second transistor at a time when a voltage at the plurality of scan electrodes reaches the third voltage if the temperature detected by the temperature detector is less than the reference temperature, and applying the turn-off control signal to the gate of the second transistor at a time when the voltage at the plurality of scan electrodes reaches the fourth voltage if the temperature detected by the temperature detector is greater than the reference temperature.

11. The driving device of claim 10, wherein the voltage generator comprises:
a third transistor having a first terminal coupled to a source of the second transistor and a second terminal coupled to the first power source;
a first resistor coupled to a control terminal of the third transistor and the first terminal of the third transistor; and
a second resistor coupled between the control terminal of the third transistor and the second terminal of the third transistor,
wherein at least one of the first resistor and the second resistor is a variable resistor having a resistance that varies according to a resistance control signal output from the controller.

12. The driving device of claim 11, wherein the resistance of the first and second resistors is determined such that a ratio of the resistance of the first resistor to the resistance of the second resistor is a first ratio when the temperature transmitted from the temperature detector is less than the reference temperature, and the resistance of the first and second resistors is determined such that the ratio of the resistance of the first resistor to the resistance of the second resistor is a second ratio that is greater than the first ratio when the temperature transmitted from the temperature detector is greater than the reference temperature.

13. The driving device of claim 11, wherein the third transistor is a bipolar transistor.

14. The driving device of claim 10, wherein the gate driving circuit coupled to the second transistor comprises:
a comparator having a first input terminal coupled to a first terminal of the second transistor coupled to the plurality of scan electrodes and a second input terminal coupled to a node of the voltage generator and the second transistor, and the comparator outputting a high level output signal when a voltage applied to the first input terminal is higher than a voltage applied to the second input terminal; and
a logic element including a first input terminal coupled to an output terminal of the comparator and a second input terminal coupled to the controller to output a turn-on-turn-off control signal of the second transistor, and to output the high level output signal when a high level signal is respectively applied to the first input terminal and the second input terminal.

15. The driving device of claim 14, wherein a low level output signal is output to the output terminal of the comparator when the voltage applied to the first input terminal of the comparator is lower than that applied to the second input terminal, and the low level output signal is output to an output terminal of the logic element.

16. The driving device of claim 15, wherein the first transistor is turned on when the low level output signal is output to the output terminal of the logic element.

17. A method for driving a plasma display comprising a plurality of scan electrodes, the method comprising:
detecting a temperature of the plasma display;
applying a voltage waveform gradually decreasing to a reset minimum voltage to the plurality of scan electrodes during a falling period of a reset period;
selectively applying a first voltage that is lower than the reset minimum voltage to the scan electrode to be selected from the plurality of scan electrodes at a time when a voltage at the plurality of scan electrodes reaches the reset minimum voltage; and
establishing a voltage difference between the reset minimum voltage and the first voltage to be a second voltage when the temperature of the plasma display is less than a reference temperature, and establishing the voltage difference to be a third voltage that is higher than the second voltage when the temperature of the plasma display is greater than the reference temperature.
